(19) United States
(12) Patent Application Publication
(10) Pub. No.: US 2026/0194339 A1
(43) Pub. Date: Jul. 9, 2026

(54) OPTOELECTRONIC DEVICE AND METHOD FOR GENERATING AN OUTPUT SIGNAL

(71) Applicant: ams Sensors Germany GmbH, Jena (DE)

(72) Inventors: Henrik THOMSEN, Holte (DK); Rene Rye LARSEN, Bagsværd (DK); Jakob Kenn TOFT, Copenhagen (DK); Claus ERDMANN FÜRST, Roskilde (DK)

(21) Appl. No.: 19/130,127

(22) PCT Filed: Oct. 24, 2023
(86) PCT No.: PCT/EP2023/079634

§ 371 Date: May 15, 2025

(30) Foreign Application Priority Data
Nov. 18, 2022 (DE) 10 2022 130 571.6

(51) Int. Cl. G01B 9/02; G01B 11/02

(52) U.S. Cl. CPC G01B 9/02092; G01B 11/026

(57) ABSTRACT

An optoelectronic device (10) is configured as a self-mixing interferometer and comprises a laser (11), a driver (20) with an output coupled to the laser (11), a signal input (21), a comparator (22) with an input (23) coupled to the signal input (21), a time-to-digital converter (25) with an input (26) coupled to an output (24) of the comparator (22), and a signal evaluation circuit (30) with an input (31) coupled to an output (27) of the time-to-digital converter (25) and with an output (32). The signal evaluation circuit (30) is configured to provide an output signal (SOUT) at the output (32). Moreover, a method for generating an output signal (SOUT) is provided.

### CROSS-REFERENCE TO RELATED APPLICATIONS

This is a US national phase of international application PCT/EP2023/079634, filed on Oct. 24, 2023, which claims priority to German patent application 10 2022 130 571.6, filed on Nov. 18, 2022, the entire contents of which are hereby incorporated by reference.

### TECHNICAL FIELD

An optoelectronic device, a distance measurement arrangement with the optoelectronic device and a method for generating an output signal are provided.

### BACKGROUND

Distances can be measured by different methods. One example are time-of-flight configurations in which electromagnetic radiation is emitted towards a target at a first point of time, the radiation is reflected by the target and the reflected radiation is detected by a photodetector at a second point of time. The distance to the target can be calculated using the duration between the first point of time and the second point of time. However, it is difficult to use this method for short distances. For short distances, a self-mixing interferometer, abbreviated SMI, can be used.

### SUMMARY

It is an object of the present application to provide an optoelectronic device, a distance measurement arrangement and a method for generating an output signal which are able to measure a distance with high accuracy.

This object is achieved by the subject-matter of the independent claims. Further embodiments and developments are given in the dependent claims.

In an embodiment, an optoelectronic device comprises a laser, a driver with an output coupled to the laser, a signal input, a comparator with an input coupled to the signal input, a time-to-digital converter with an input coupled to an output of the comparator, and a signal evaluation circuit. The signal evaluation circuit comprises an input coupled to an output of the time-to-digital converter. The signal evaluation circuit is configured to provide an output signal at an output of the signal evaluation circuit.

Advantageously, the comparator is used to exactly determine a point of time at which the time-to-digital converter, abbreviated TDC, starts and/or stops operating to determine a duration.

In an embodiment, the optoelectronic device is configured as a self-mixing interferometer. In an example, the electromagnetic radiation emitted by the laser and further electromagnetic radiation such as reflected electromagnetic radiation mixes inside the optoelectronic device, e.g. inside the laser.

In an embodiment of the optoelectronic device, the laser is realized as vertical-cavity surface-emitting laser, abbreviated VCSEL, edge emitting laser or edge emitting semiconductor laser. The electromagnetic radiation emitted by the laser is e.g. light. The electromagnetic radiation is in a range between 400 nm and 2000 nm, in a range between 600 nm and 1300 nm, in a range between 840 nm and 1040 nm or in a range between 920 nm and 960 nm. For example, the laser is operated in a pulse mode; the laser is driven by pulses. In an example, the laser does not continuously emit electromagnetic radiation. Alternatively, the laser continuously emits electromagnetic radiation; e.g. the laser emits a modulated electromagnetic radiation which is added on top of a baseline value of electromagnetic radiation.

In an embodiment of the optoelectronic device, the comparator is implemented as a Schmitt trigger circuit or as an amplifier. The amplifier is e.g. an operational amplifier. The amplifier has a high gain. For example, a gain factor of the amplifier is larger than 10 or larger than 100 or larger than 1000.

In an example, the comparator is implemented as a comparator with hysteresis such as e.g. a Schmitt trigger circuit. In an alternative example, the comparator is implemented as a comparator without hysteresis.

In an embodiment of the optoelectronic device, the driver is configured to provide a laser current to the laser. The laser current has a pulse form. A pulse of the laser current is periodically repeated.

In an embodiment of the optoelectronic device, the TDC is configured to measure a duration between two edges and to generate a duration signal as a function of the duration between the two edges. The duration signal can be named pulse width signal. The duration signal is configured e.g. to include the information about a duration of a pulse. The duration of the pulse can be named width or length of the pulse. Alternatively, the duration signal is configured e.g. to include the information about a duration between edges of two pulses. The edges can be rising and falling edges.

In an embodiment of the optoelectronic device, an input signal is tapped at the signal input. A control signal is tapped at an input of the driver and/or applied to the input of the driver.

In an embodiment of the optoelectronic device, the first edge is a rising edge of the laser current, an edge of the control signal (this edge of the control signal triggers the rising edge of the laser current), an edge of the input signal or an edge of a signal derived from the input signal. The second edge is a further edge of the input signal or a further edge of the signal derived from the input signal.

In an example, the first edge represents a start of the pulse of the laser current which can be detected at an input or output side of the driver and at an output side of the photodetector. The second edge is detected at the output side of the photodetector via the comparator and is a function of a distance difference. For example, the distance difference results from a movement of a target with respect to a start position.

In an alternative embodiment of the optoelectronic device, the first edge is an edge of the input signal or an edge of a signal derived from the input signal. The second edge is a falling edge of the laser current, an edge of the control signal (this edge of the control signal triggers the falling edge of the laser current), a further edge of the input signal or a further edge of the signal derived from the input signal.

In an example, the second edge represents an end of the pulse of the laser current which can be detected at the input or output side of the driver and at the output side of the photodetector. The first edge is detected at the output side of the photodetector via the comparator and is a function of the distance difference.

In an example, the first edge and the second edge are detected at the output side of the photodetector via the comparator. The first edge and the second edge are e.g. both a function of the distance difference or one of the first and the second edge is a function of the distance difference.

In an embodiment of the optoelectronic device, the signal evaluation circuit is configured to linearize the duration signal provided by the TDC.

In an embodiment of the optoelectronic device, the signal evaluation circuit is configured to linearize the duration signal by generating a warped signal by warping the duration signal and generating an unwrapped signal by unwrapping the warped signal.

In an embodiment of the optoelectronic device, generating the warped signal by warping the duration signal is performed by polynomial or piecewise polynomial evaluating the duration signal.

In an embodiment of the optoelectronic device, generating the unwrapped signal by unwrapping the warped signal is performed by using the equation:

YU(n)=function_unwrap(YW(n),C,Y_SMI_PERIOD),
wherein YU(n) is a nth value of the unwrapped signal, YW(n) is a nth value of the warped signal, C is an integer and Y_SMI_PERIOD is a constant. The constant is a SMI period and is determined e.g. during fabrication or calibration. C is e.g. a positive integer, a negative integer or 0.

In a further development of the optoelectronic device, generating the unwrapped signal by unwrapping the warped signal is performed by using the equation:

$$YU ( n ) = function\_unwrap ( YW ( n ) , C , Y\_SMI \_PERIOD , RESET ) ,$$

wherein YU(n) is a nth value of the unwrapped signal, YW(n) is a nth value of the warped signal, C is an integer, Y_SMI_PERIOD is a SMI period and RESET is a start or reset value.

In an embodiment of the optoelectronic device, the signal evaluation circuit comprises a look-up table and is configured to linearize the duration signal using the look-up table.

In an embodiment of the optoelectronic device, the signal evaluation circuit is configured to generate the output signal by filtering and/or amplification the unwrapped signal. The filtering is realized e.g. as digitally high-pass filtering. Advantageously, the filtering removes an unwanted large DC component (this DC component may have low-frequency components as well). Digital amplification is performed after high-pass filtering to adjust for a certain sensitivity of a microphone.

In an embodiment of the optoelectronic device, the TDC comprises a time-to-voltage converter and a voltage-to-digital converter. The time-to-voltage converter is coupled to the input of the TDC. The voltage-to-digital converter is coupled to an output of the time-to-voltage converter and to the output of the TDC.

In an embodiment of the optoelectronic device, the signal input is coupled to the laser. The signal input is configured to receive a laser voltage tapped at the laser. The laser voltage shows e.g. a self-mixing interferometer effect, abbreviated SMI effect.

In an embodiment, the optoelectronic device comprises a photodetector with an output coupled to the signal input. The photodetector is e.g. one of group consisting of a photodiode, a phototransistor, a pinned photodiode and a light emitting diode, abbreviated LED. The LED is reverse-biased to act as photodiode. A photodetector current generated by the photodetector shows e.g. the SMI effect.

In an embodiment, a distance measurement arrangement comprises the optoelectronic device and a target. The laser is configured to emit electromagnetic radiation. The electromagnetic radiation is e.g. light in the visible range. The target is configured to provide electromagnetic radiation as reflected radiation to the optoelectronic device. The optoelectronic device is configured to detect the reflected radiation. In other words, an input signal is provided, generated or tapped at an input side of the optoelectronic device that depends on the reflected radiation; for example, the input signal depends on the phase and the amplitude of the reflected electromagnetic radiation. More specifically, the target is configured to provide a portion of the electromagnetic radiation as reflected radiation to the optoelectronic device. The optoelectronic device is configured to detect or evaluate a portion of the reflected radiation.

In an example, the portion of the reflected radiation is detected by the photodetector or the laser. The portion of the reflected radiation mixes with the electromagnetic radiation inside the optoelectronic device, e.g. in the laser.

In an embodiment, the distance measurement arrangement is configured that the reflected radiation is transmitted from the target through the laser to the photodetector or is transmitted through the photodetector to the laser. In the second case the reflected radiation is e.g. directly transmitted from the target to the photodetector. The photodetector is configured to detect a portion of the reflected radiation. In an example, the target, the photodetector and the laser are located on a straight line. The target is at an end of the straight line. The positions of the photodetector and the laser on the straight line can be interchanged. For example, the reflected radiation is absorbed by the laser; the reflected radiation affects the laser such that the radiated light changes and hence the radiation observed by the photodetector is different.

In an embodiment of the distance measurement arrangement, the signal evaluation circuit is configured that the output signal of the optoelectronic device is an audio signal.

In an embodiment of the distance measurement arrangement, the target is a membrane of a microphone or a display. Advantageously, a movement of the membrane or the display caused e.g. by an audio signal is detected by the optoelectronic device. A value of the movement is called distance difference.

The optoelectronic device described above is particularly suitable for the distance measurement arrangement. Features described in connection with the optoelectronic device can therefore be used for the distance measurement arrangement and vice versa.

In an embodiment, a method for generating an output signal comprises:
emitting electromagnetic radiation by a laser,
generating an input signal at a signal input as a function of a reflected radiation,
generating a comparator signal by comparing the input signal or a signal derived from the input signal with a threshold value by a comparator,
generating a duration signal by a TDC as a function of the comparator signal, and
providing an output signal by a signal evaluation circuit as a function of the duration signal.

Advantageously, the comparator provides a start signal or a stop signal or a start and a stop signal of a duration that is converted into a digital value by the TDC.

The optoelectronic device and the distance measurement arrangement described above are particularly suitable for the method for generating an output signal. Features described in connection with optoelectronic device and the distance measurement arrangement can therefore be used for the method and vice versa.

In an example, the method is used with a membrane of a microphone or a microphone package. Alternatively, the method is used with a cell phone display as a membrane and, thus, without using a traditional microphone or microphone package.

In an example, the method performs a direct position sensing (abbreviated DPS) using SMI. The optoelectronic device is designed to be used in high resolution distance measurement for membrane movements, i.e. to realize an acoustical to digital output readout method. The optoelectronic device achieves a high signal-to-noise ratio (abbreviated SNR), low cost and low power. The optoelectronic device implements a high resolution membrane or target distance measurement (e.g. a high resolution membrane/target movement beyond lambda/2), a fast acquisition of membrane/target movements, a direct measurement of the pulse length from a SMI response using the steep edge of the fringe and a pulsing of the VCSEL current at high rate (a sample frequency fs is measured in Hz) with low duty cycle to generate SMI response through heating of the VCSEL.

In an example, pulses of the laser current have a pulsing rate in a range between 30 kHz and 300 kHz or between 60 kHz and 200 kHz or between 70 kHz and 180 kHz. In a low power configuration of a microphone the pulsing rate is e.g. 75 kHz. A duration of a pulse of the laser current is in a range between 0.1 μs and 50 μs or in a range between 0.2 μs and 30 μs or in a range between 0.2 μs and 2 μs. Typically, the duration is e.g. 0.9 μs. The output signal of the optoelectronic device has e.g. one value per each pulse. Thus, a sampling frequency of the optoelectronic device is equal to the pulsing rate or lower than the pulsing rate. The sampling frequency in Hertz is sometimes referred to as number of samples/second.

In an example, the distance measurement arrangement estimates/tracks, with high resolution and low distortions, the displacement of a membrane used to readout acoustical pressure changes in the audible range with respect to frequency and dynamic range, i.e. an optical microphone solution. The distance measurement arrangement can also be used when a non-traditional membrane, such as a display in a mobile phone, is used as a membrane. The distance measurement arrangement also solves the beyond lambda/2 displacement, e.g. with the same resolution, which the traditional open loop/closed loop tracking using lambda tuning cannot meet. The distance measurement arrangement can be used to track/estimate membrane movements or other distance changes.

In an example, the distance measurement arrangement uses the pulsed VCSEL current to generate the SMI response. This significant saves VCSEL drive power compared to closed/open loop solutions. The distance measurement arrangement is configured for direct positions sensing, abbreviated DPS. The distance measurement arrangement only needs one fringe which saves VCSEL drive power. The distance measurement arrangement directly measures the pulse length from start of VCSEL pulse to the steep fringe edge, or alternatively from the steep fringe edge to the end of VCSEL pulse. The distance measurement arrangement does not perform an amplitude-based measurement. This makes the distance measurement arrangement superior with respect to noise suppression from shot noise sources. The complexity of the distance measurement arrangement is low, since it needs only a few one-time-programmable bits (e.g. about 200 bits) and analog-to-digital conversions. The circuitry of the distance measurement arrangement runs only at a fraction of speed compared to other arrangements. The distance measurement arrangement for DPS can track a wavenumber in the SMI response making it possible to support beyond lambda/2 membrane excursion measurements.

### BRIEF DESCRIPTION OF THE DRAWINGS

The following description of figures of examples or embodiments may further illustrate and explain aspects of the optoelectronic device, the distance measurement arrangement and the method for generating an output signal. Arrangements, processes, devices and circuit blocks with the same structure and the same effect, respectively, appear with equivalent reference symbols. In so far as arrangements, processes, devices and circuit blocks correspond to one another in terms of their function in different figures, the description thereof is not repeated for each of the following figures.

FIGS. 1A to 1E show exemplary embodiments of a distance measurement arrangement with an optoelectronic device;

FIGS. 2A to 2H show exemplary signals and characteristics of a distance measurement arrangement with an optoelectronic device, and

FIGS. 3A to 3J show further exemplary signals and characteristics of a distance measurement arrangement with an optoelectronic device.

### DETAILED DESCRIPTION

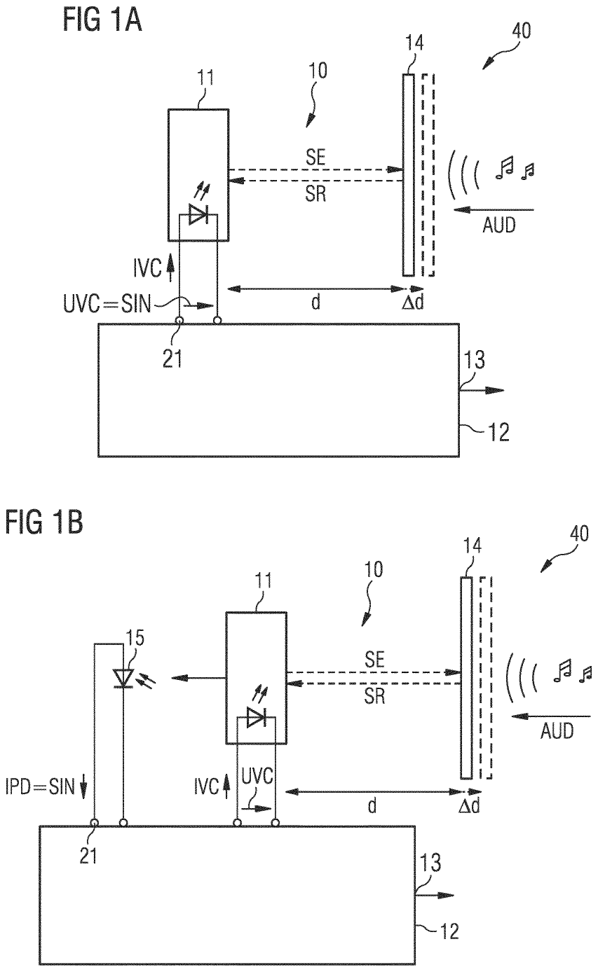

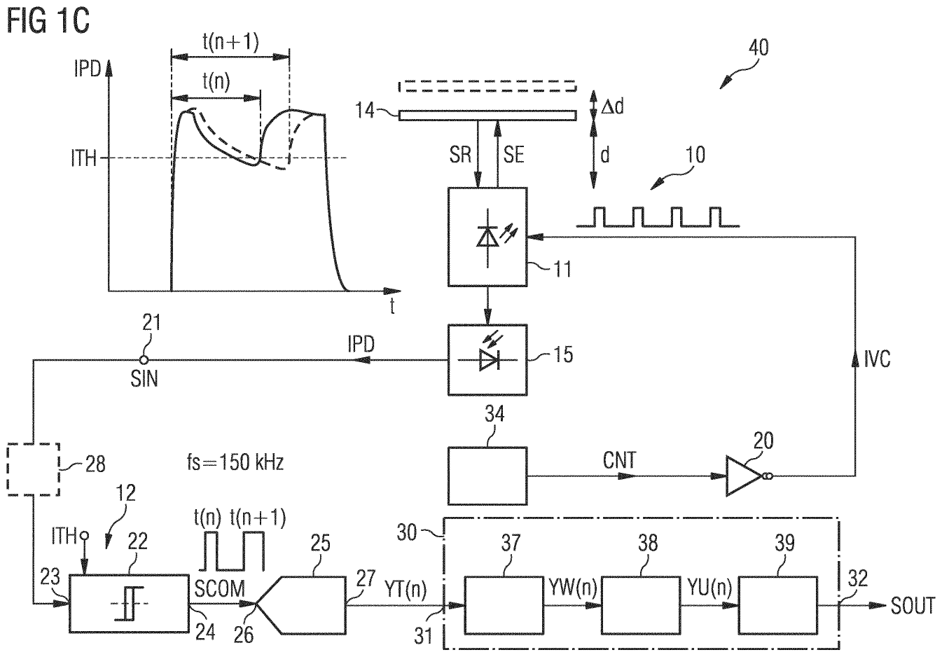

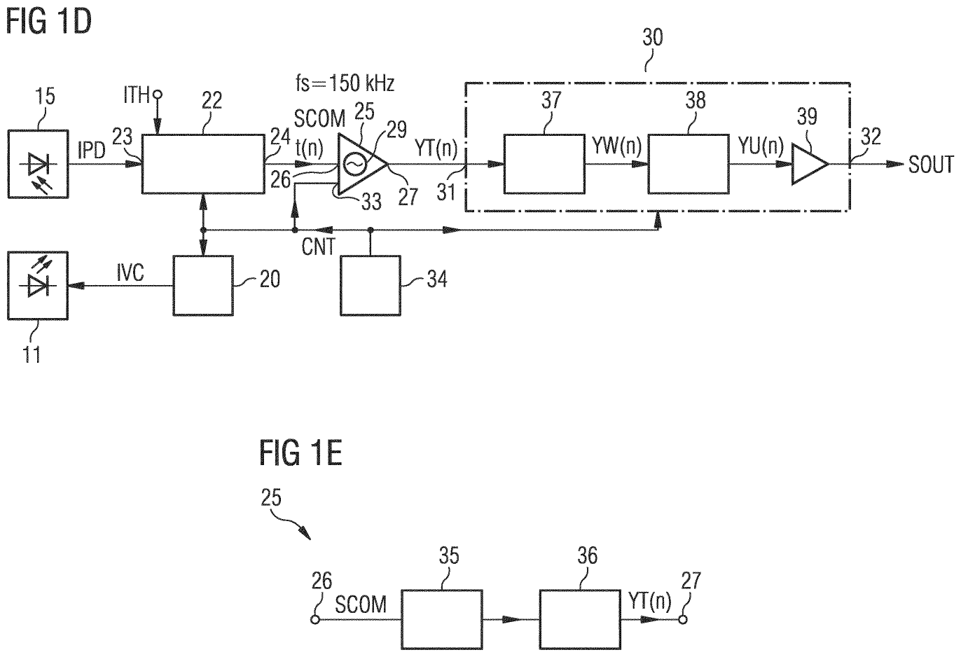

FIG. 1A shows an exemplary embodiment of a distance measurement arrangement 40 with an optoelectronic device 10. The distance measurement arrangement 40 comprises the optoelectronic device 10 and a target 14. The optoelectronic device 10 comprises a laser 11 and a signal input 21. The optoelectronic device 10 comprises an integrated circuit 12. The integrated circuit 12, abbreviated IC, can be implemented as application specific integrated circuit, abbreviated ASIC. A driver 20 of the IC 12 (as shown in FIGS. 1C and 1D) is coupled to the laser 11. The laser 11 is coupled via the signal input 21 to the integrated circuit 12. The integrated circuit 12 for example includes an output 13. The optoelectronic device 10 is implemented as self-mixing interferometer. The laser 11 is realized as vertical-cavity surface-emitting laser. The target 14 is a membrane of a microphone or a display. The target 14 can have the function of a mirror.

The driver 20 of the IC 12 provides a laser current IVC to the laser 11. The laser 11 emits electromagnetic radiation SE. The target 14 provides a portion of the electromagnetic radiation SE as reflected radiation SR to the optoelectronic device 10. The reflected radiation SR is provided to the laser 11 and the reflected radiation SR is mixing with the electromagnetic radiation SE and generates the self-mixing interferometer effect, abbreviated SMI effect. The optoelectronic device 10 detects a portion of the reflected radiation SR; more exactly the laser 11 detects the reflected radiation SR. A laser voltage UVC is tapped between the two terminals of the laser 11. The laser voltage UVC is a function of the reflected radiation SR (the SMI signal with the steep edge is found in the laser voltage UVC). The laser voltage UVC includes an information about a distance d from the laser 11 to the target 14. The laser voltage UVC is an input signal SIN of the optoelectronic device 10. An output signal is provided at the output 13 of the integrated circuit 12. The output signal includes the information about the distance d. As can be seen in FIG. 1A, the target 14 moves or vibrates due to an audio input signal AUD. The target 14 moves by a distance called distance difference Δd. The output signal of the optoelectronic device 10 is an audio signal.

FIG. 1B shows an exemplary embodiment of a distance measurement arrangement 40 with an optoelectronic device 10 which is further development of the embodiment shown in FIG. 1A. The optoelectronic device 10 includes a photodetector 15. The photodetector 15 is coupled to the integrated circuit 12. Thus, the photodetector 15 is coupled via the signal input 21 to the integrated circuit 12. The photodetector 15 generates a photodetector current IPD. The photodetector current IPD is the input signal SIN of the optoelectronic device 10.

The distance measurement arrangement 40 is arranged such that the reflected radiation SR is transmitted through the laser 11 to the photodetector 15. The photodetector 15 detects a portion of the reflected radiation SR. The reflected radiation SR is the optical SMI signal with the steep edge that is detected with a comparator 22 (shown in FIGS. 1C and 1D).

The optoelectronic device 10 is configured for a microphone with optical readout. The readout is based on self-mixing interference (abbreviated SMI): a laser beam emitted by the VCSEL 11 is directed onto a reflective membrane (that implements the target 14) which moves with the applied sound pressure AUD. The reflected laser radiation SR is fed back into the VCSEL 11, which causes it to influence the operation of the VCSEL 11 by light interference or radiation interference. Since the reflected radiation SR experiences a varying phase shift depending on the membrane position, the overall radiation intensity is varying which can be captured by either sensing the radiation intensity with the photodetector 15 (power or current readout) or by sensing the voltage/current characteristic (e.g. voltage readout) of the laser 11. A phase shift of the reflected radiation SR can be calculated as:

$${φ}_{0} = 2 π \cdot \frac{2 d}{λ} ,$$

wherein λ is a radiation wavelength of the laser 11 and d is a distance from the laser 11 to the target 14.

The IC 12 comprises e.g. the read out with a TDC 25 etc. The IC 12 or the ASIC performs the task of controlling/generating a VCSEL drive current IVC and sensing of the current IPD from the photodiode 15. The IC 12 can also sense the voltage UVC across the VCSEL 11. Also, the IC 12 performs the task of estimating the pulse length signal from the SMI response (d variations) and convert these into audio signals, this is the algorithm part of the DPS systems. A method/distance measurement arrangement 40 that estimates/tracks, with a high resolution and low distortions, the displacement of the membrane used to readout the acoustical pressure changes AUD in the audible range with respect to frequency and dynamic range, i.e. an optical microphone solution. The distance measurement arrangement can be used to track/estimate any distances changes not only applicable to microphones. The optoelectronic device 10 is configured on tracking of membrane movements.

In an alternative, not shown embodiment, the distance measurement arrangement 40 is arranged such that the reflected radiation SR is directly transmitted to the photodetector 15. Thus, an optical path from the target 14 to the photodetector 15 is free from the laser 11.

In an alternative, not shown embodiment, the photodetector 15 is placed at another place in the optical path. In an example, the photodetector is realized as a semi-transparent photodiode located between the laser 11 and the target 14. The radiation from the laser 11 passes through the photodiode 15 before it hits the target 14, and the reflected radiation SR is likewise passing through the photodiode 15 before hitting the laser 11 again.

FIG. 1C shows an exemplary embodiment of a distance measurement arrangement 40 with an optoelectronic device 10 which is a further development of the embodiments shown in FIGS. 1A and 1B. The optoelectronic device 10 comprises a driver 20 with an output coupled to the laser 11. An output of a control circuit 34 of the optoelectronic device 10 is connected to an input of the driver 20. The driver 20 is configured as amplifier, buffer, pulse generator or clock circuit. The amplifier is for example realized as operational transconductance amplifier, abbreviated OTA. The laser current IVC has a pulse form. The pulses of the laser current IVC are e.g. rectangular. A value of a pulse of the laser current IVC is in a range between 0.1 mA and 20 mA or between 0.5 mA and 5 mA.

The optoelectronic device 10 comprises the photodetector 15 with an output coupled to the signal input 21. The optoelectronic device 10 comprises a comparator 22 with an input 23 coupled to the signal input 21, a time-to-digital converter 25 (abbreviated TDC) with an input 26 coupled to an output 24 of the comparator 22, and a signal evaluation circuit 30 with an input 31 coupled to an output 27 of the TDC 25. The comparator 22 is implemented e.g. as a Schmitt trigger circuit. Thus, the comparator 22 has a hysteresis. The signal evaluation circuit 30 has an output 32.

The driver 20 provides the laser current IVC to the laser 11. The laser current IVC has a pulse form. The laser current IVC includes a series of pulses. A pulse of the series of pulses is periodically repeated. The photodetector 15 generates the photodetector signal IPD which is the input signal SIN. The input signal SIN is provided via the signal input 21 to the input 23 of the comparator 22. The comparator 22 generates a comparator signal SCOM as a function of the input signal SIN. The comparator 22 compares the input signal SIN with a threshold value ITH and generates the comparator signal SCOM as a result of the comparison. The comparator signal SCOM includes pulses t(n), t(n+1) such as shown in FIG. 1C. The comparator signal SCOM is provided to the TDC 25. The comparator signal SCOM is applied to the input 26 of the TDC 25. The TDC 25 generates a duration signal YT or YT(n) as a function of the comparator signal SCOM. “n” stands for the number of a sample, e.g. the nth pulse or the nth duration signal YT. The duration signal YT is provided to the signal evaluation circuit 30. The signal attenuation circuit 30 generates the output signal SOUT as a function of the duration signal YT at the output 32. The output signal SOUT is a digital audio signal.

The comparator 22 detects e.g. two edges of the input signal SIN provided at the signal input 21 or two edges of a signal derived from the input signal SIN. The TDC 25 measures a duration between the two edges and generates the duration signal YT as a function of the duration between the two edges. As shown in FIG. 1C on the left side, the photodetector current IDP and thus the input signal SIN has a first edge at which the input signal SIN rises above the threshold value ITH. Further on, the photodetector current IDP and thus the input signal SIN has a second edge at which the input signal SIN rises above the threshold value ITH. The first and the second edge are rising edges.

In an example, the comparator 22 is configured to generate the comparator signal SCOM such that the comparator signal SCOM indicates the distance between the first edge and the second edge. For example, the comparator signal SCOM includes a pulse with the duration which is equal to the distance between the first edge and the second edge. The TDC 25 is configured to generate the duration signal YT by digitizing this duration. The TDC e.g. uses the rising edge of the pulse of the comparator signal SCOM as start signal and the falling edge of the pulse of the comparator signal SCOM as stop signal. As indicated in FIG. 1C, the comparator signal SCOM has a pulse t(n) and a pulse t(n+1) which follows the pulse t(n). A duration of the pulse t(n) is shorter than a duration of the pulse t(n+1) as can be seen in the curve shown in FIG. 1C.

Alternatively (as explained in FIG. 1D), the TDC 25 measures a duration between a start of a pulse of the laser current IVC and one edge of the input signal SIN or alternatively between one edge of the input signal SIN and an end of the pulse of the laser current IVC. Typically, an edge of the input signal SIN which is used for the comparator 22 is a steep edge.

Advantageously, the use of the steep edge of the fringe allows an exact determination of a point of time. In an example, the steep edge of the input signal SIN is provided via the comparator 22 to a start input of the TDC 25 and a signal derived from a control signal CNT of the driver 20 is provided to a stop input of the TDC 25. The derived signal is a falling edge of the control signal CNT that controls the driver 20.

The signal evaluation circuit 30 linearizes the duration signal YT provided by the TDC 25. The signal evaluation circuit 30 performs several processes or steps to provide the output signal SOUT. In a first process 37, the signal evaluation circuit 30 generates a warped signal YW by warping the duration signal YT. In a second process 38, the signal evaluation circuit 30 generates an unwrapped signal YU by unwrapping the warped signal YW. In a third process 39, the signal evaluation circuit 30 generates the output signal SOUT by amplification and/or filtering the unwrapped signal YU. The amplification is performed for gain adjustment. The filtering is e.g. a high-pass filtering or a band-pass filtering. The duration signal YT, the warped signal YW, the unwrapped signal YU and the output signal SOUT are digital signals (the “(n)” stands for the nth sample).

In an example, the signal evaluation circuit 30 is realized as a digital logic circuit, e.g. as combinatorial digital logic circuit or state machine. The signal evaluation circuit 30 comprises at least one of logic gates, flip-flops and one-time programmable bits. The logic cells are described on a register-transfer level, abbreviated RTL. In an example, the signal evaluation circuit 30 is free of a computer, microprocessor and microcontroller.

In an alternative example, the signal evaluation circuit 30 is implemented as microprocessor or microcontroller. The signal evaluation circuit 30 includes a memory for example for storing a computer program product. The computer program product comprises instructions to cause the optoelectronic device 10 or the distance measurement arrangement 40 to execute the method described here.

The method for generating the output signal SOUT comprises emitting electromagnetic radiation SE by the laser 11, generating the input signal SIN at the signal input 21 as a function of the reflected radiation SR, generating the comparator signal SCOM by comparing the input signal SIN or a signal derived from the input signal SIN with the threshold value ITH by the comparator 22, generating the duration signal YT by the TDC 25 as a function of the comparator signal SCOM, and providing the output signal SOUT by the signal evaluation circuit 30 as a function of the duration signal YT. The threshold value ITH has e.g. a positive or a negative value or is 0.

The distance measurement arrangement 40 is realized such that the laser current IVC is pulsed for approximately e.g. 0.9 μs at a rate of e.g. 150 kHz. This stimulus is used for DPS readout algorithm. Each pulse of the laser current IVC heats up the laser 11 that generates a SMI response due to the change in the laser wavelength lambda k. Each SMI response is shifted in phase/time that changes when the optical distance d changes by the distance difference Δd. The DPS readout algorithm estimates this phase/time shift with the comparator 22.

In an alternative embodiment, as shown in FIG. 1A, the signal input 21 is coupled to the laser 11 and receives a laser voltage UVC tapped at the laser 11. The laser voltage UVC is provided between the two terminals of the laser 11. The input signal SIN is the laser voltage UVC.

In an alternative embodiment, indicated by dashed lines, the optoelectronic device 10 comprises a subtracting/additive circuit 28 that couples the photodetector 15 to the input 23 of the comparator 22. Thus, an input signal of the comparator 22 is equal to the photodetector current IPD minus or plus a reference value. The reference value is e.g. constant or variable. The subtracting/additive circuit 28 is optional and can be replaced by a connection line. The subtracting/additive circuit 28 subtracts the reference value from the input signal SIN or adds the reference value to the input signal SIN during the pulse in order to set the threshold for the comparator 22. Typically, the input signal SIN is a current. A second input of the comparator 22 may be connected to ground; in this case, the threshold value ITH of the comparator 22 e.g. equals 0 or a small value.

In another embodiment, the subtracting/additive circuit 28 subtracts the mean value of the input signal SIN from the input signal SIN or adds the mean value of the input signal SIN to the input signal SIN during a pulse.

In an alternative, not shown embodiment, the comparator 22 is free of a hysteresis.

FIG. 1D shows an exemplary embodiment of details of an optoelectronic device 10 which is a further development of the embodiments shown in FIGS. 1A to 1C. The method for DPS comprises four basic steps or processes: Comparator front end, time-to-digital conversion, time warping and SMI unwrapping. The comparator 22 is part of an analog front end. The comparator 22 performs an edge detection. The duration t(n) is a second level signal with variable length. The comparator 22 is additionally coupled e.g. to the driver 20 or to the control circuit 34 to achieve a control of the pulses of the laser current IVC. The TDC 25 comprises an oscillator 29. Furthermore, the TDC 25 comprises a counter circuit. The oscillator 29 is e.g. a ring-oscillator. The TDC 25 performs a time-to-digital conversion by counting time (e.g. by counting pulses of the oscillator 29) for the period that is the input to the TDC 25. There are many possible approaches for implementation of the TDC 25.

The TDC 25 performs a digital conversion of the pulse length t(n) and generates the duration signal YT(n). The TDC 25 has a further input 33. The control circuit 34 is coupled to the further input 33. The control circuit 34 provides the control signal CNT to the further input 33. In an example, the further input 33 is a start input and the input 26 is a stop input. Thus, the TDC 25 starts measuring the duration with an edge (e.g. a rising edge) of a pulse of the control signal CNT and ends measuring at an edge of the comparator signal SCOM, e.g. at a falling edge of the pulse t(n) or t(n+1).

Thus, the TDC 25 generates the duration signal YT as a function of the duration between the first edge and the second edge. The first edge is an edge of the control signal CNT (which is nearly identical with a rising edge of the laser current IVC or with an edge of the input signal SIN). The second edge is a further edge of the input signal SIN or a further edge of the signal derived from the input signal SIN. The comparator signal SCOM provides the second edge to the input 26 of the TDC 25.

In the digital domain, a time warping of the duration signal YT(n) which is dependent on the wavelength λ is performed in the first process or block 37 to generate the warped signal YW(n). The warped signal YW(n) is unwrapped in the second process or block 38 to generate the unwrapped signal YU. In the third process or block 39, the unwrapped signal YU(n) is amplified with a gain to perform a sensitivity adjustment in order to generate the output signal SOUT.

An unwrapping of the warped signal YW(n) to the unwrapped signal YU(n) is e.g. realized by the following calculations or steps used in a digital design of the second process 38 in FIGS. 1C and 1D. Y_SMI_period is a constant found during calibration and is e.g. in a range between 100 ns and 2000 ns, typically =600 ns. C is a constant that is e.g. in a range between 0 and 1.0, typically 0.5. unwrap is initialized to zero at power-up. The unwrapping is a method or algorithm that takes the warped signal YW(n), sample by sample, and performs the procedure or operation described below.

The procedure to calculate the unwrapped signal YU(n) implements the following calculations or steps:

```
For each input sample calculate:
diff(n) = YW(n) − YW(n−1);
If diff(n) > C · Y_SMI_period begin
  unwrap = unwrap − Y_SMI_period;
elseif diff(n) < − C · Y_SMI_period begin
  unwrap = unwrap + Y_SMI_period;
else
  unwrap = unwrap;
end
YU(n) = YW(n) + unwrap;
```

Thus, the unwrapped signal can be calculated according the equation:

YU(n) = function_unwrap(YW(n), C, Y_SMI_PERIOD, RESET)
RESET is a start or reset value. In an example, RESET = 0.

In an alternative embodiment, the input 26 of the TDC 25 is a start input and the further input 33 of the TDC 25 is a stop input. The TDC 25 generates the duration signal YT as a function of the duration between the first and the second edge. The first edge is an edge of the input signal SIN (said edge is the rising edge which is near the end of the pulse of the input signal SIN). The second edge is an edge of the control signal CNT (which is nearly identical with a falling edge of the laser current IVC).

FIG. 1E shows an exemplary embodiment of a detail of an optoelectronic device 10 which is a further development of the embodiments shown in FIGS. 1A to 1D. The TDC 25 comprises a time-to-voltage converter 35 coupled to the input 26 of the time-to-digital converter 25. The TDC 25 comprises a voltage-to-digital converter 36 coupled to an output of the time-to-voltage converter 35 and to the output 27 of the time-to-digital converter 25.

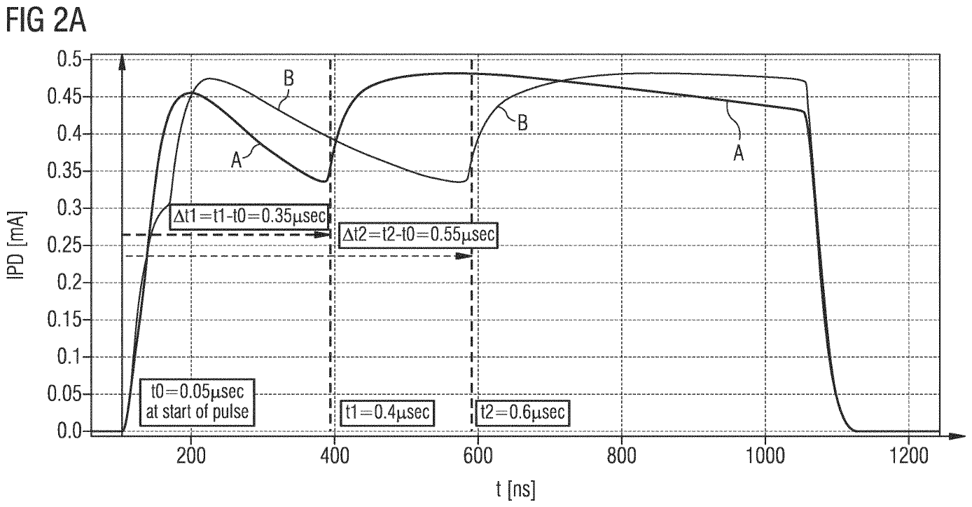

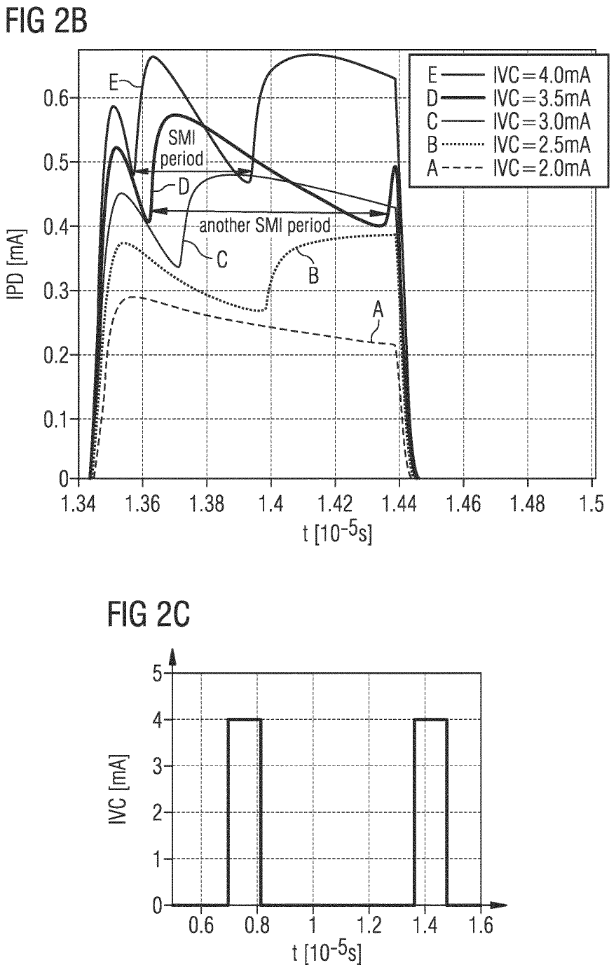

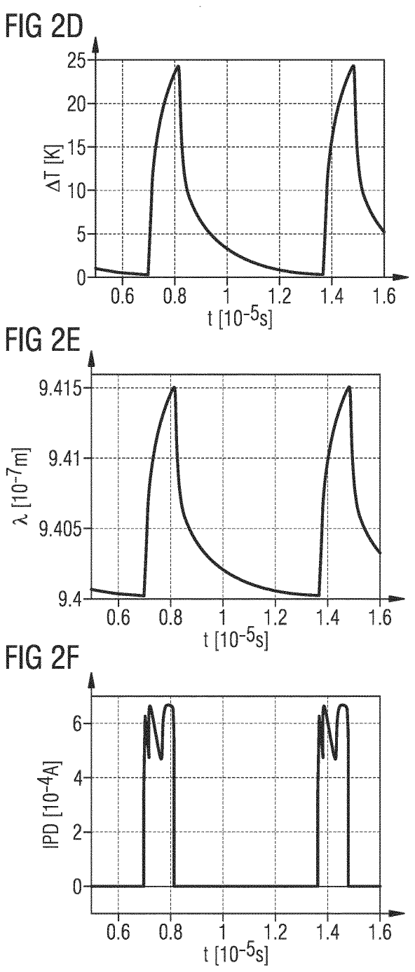

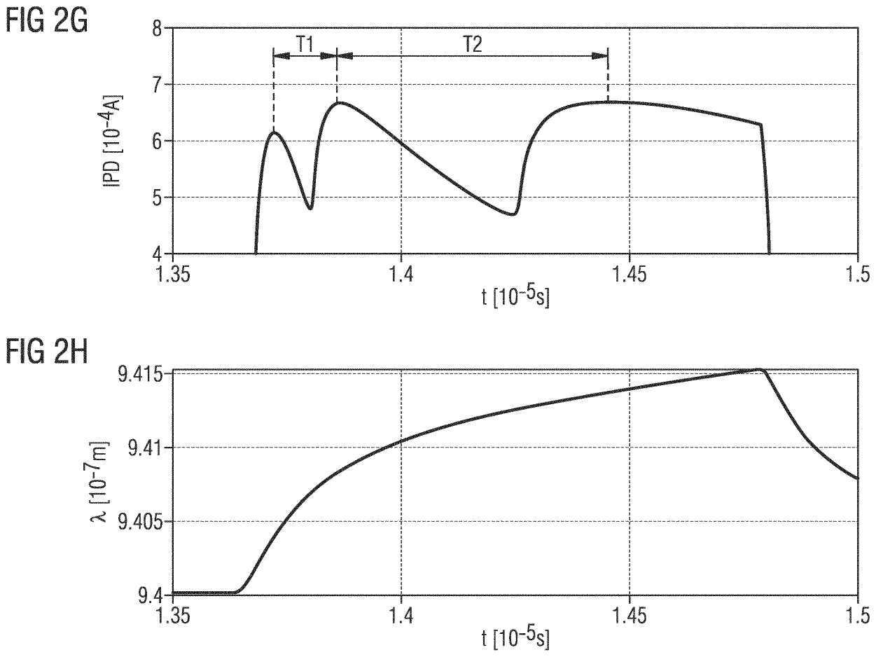

FIG. 2A shows an exemplary embodiment of signals of a distance measurement arrangement 40 with an optoelectronic device 10 which is a further development of the embodiments shown above. The photodetector current IPD is shown as a function of a time t. The photodetector current IPD at a distance difference Δd=0 is marked with A and the photodetector current IPD at a distance difference Δd=117.5 nm is marked with B. A concept of a DPS read-out algorithm is as follows: The optoelectronic device 10 pulses the laser current IVC for approximately 0.9 μs at a rate of 150 kHz. Each pulse heats up the laser 11 that generates a SMI responses due to the change in the wavelength λ. Each SMI response is shifted in phase/time that changes when the optical distance d changes. The readout algorithm estimates this phase/time shift. This stimulus is used for the DPS readout algorithm.

The optoelectronic device 10 measures the time from start of the pulse of the laser current IVC to a positive steep edge of the SMI response. The steep edge of the SMI response is chosen in order to minimize an influence of noise from the photodetector 15. The start pulse can be the control signal CNT to the driver 20 or it can be derived from the laser current IVC itself by another comparator of the optoelectronic device 10. The control signal CNT is already digital. The control signal CNT is a pulse signal. In an example, a pulse of the control signal CNT has a length of a desired pulse of the laser current IVC or has another length.

Alternatively, the duration from the steep edge of the input signal to the end of the laser current IVC or of the control signal CNT to the driver 34 is measured by the TDC 25. Thus, the steep edge of the input signal SIN is either provided to a start input of the TDC 25 or to a stop input of the TDC 25.

$$The DPS output samples : \{ Δ t 1 , Δ t 2 \} = \{ 0.35 μs , 0.55 μs \}$$

The SMI response repeats itself for every λ/2 change of the optical distance d. In the example in FIG. 2B with Δd=117.5 nm and Δd=117.5 nm+471 nm (approximately λ/2=470 nm). This corresponds to a 2·π (written also as 2π) change of SMI phase. A simple unwrapping algorithm that tracks how many 27L has passed solves the AOP problem. AOP stands for acoustical overload point or acoustic overload point which is defined as the maximum operating amplitude of the acoustical signal typically around 130 dBspl. For a typical implementation the phase may change more than 2π at a level around 110 dB which means that the SMI signal has wrapped 2π. The unwrapping process 38 does this algorithm to keep track of the number of 2π that has occurred or equivalent what the wavenumber the current fringe represent. In DPS the output is in seconds and, therefore, a SMI period for a fringe is measured in seconds.

FIG. 2B shows an exemplary embodiment of signals of a distance measurement arrangement 40 with an optoelectronic device 10 which is a further development of the embodiments shown above. Different SMI responses are plotted from PD output during a 0.9 μs pulse. The membrane is in idle or rest position i.e. there is no change of the optical distance d. The pulses of the laser current IVC have a duty cycle in a range between 1% and 20%. The position and number of SMI periods changes with a value of the laser current IVC. The SMI periods and their changes result from the heating property of the laser 11. The optoelectronic device 10 is configured to handle several SMI periods within the same pulse, e.g. by measuring the pulse length to the last steep edge. In case the value of the laser current IVC is too low (in this example of the laser 11 e.g. at IVC=2.0 mA), SMI occurs, but no fringes appear, rendering it unusable for DPS.

FIG. 2C to 2H show exemplary embodiments of signals of a distance measurement arrangement 40 with an optoelectronic device 10 which is a further development of the embodiments shown above. In FIGS. 2C to 2H, the physical relations are elucidated. In DPS, self-heating of the VCSEL 11 is used to create SMI modulation.

In FIG. 2C, the laser current IVC is shown as a function of the time t. Thus, two pulses of the laser current IVC are applied to the VCSEL 11.

In FIG. 2D, a temperature change ΔT is shown as a function of the time t. Thus, the laser current IVC results in a heating of the VCSEL 11.

In FIG. 2E and also in FIG. 2H, a wavelength λ of the laser 11 is shown as a function of the time t. A wavelength tuning occurs due to the temperature change ΔT.

In FIG. 2F, the photodetector current IPD is shown as a function of the time t. A SMI modulation occurs in each pulse.

In FIG. 2G, a first pulse of the photodetector current IPD is shown as a function of the time t. In this example, there are two SMI periods in the first pulse (and also in the second pulse). They have different widths denoted T1 and T2. The two SMI periods are created by the change in wavelength over time according to a phase excess equation (even when Lop(t) is constant):

$$φ ( t ) = 2 π 2 Lop ( t ) / λ ( t ) ;$$

wherein Lopt(t) is the optical distance which will vary with a time t if the membrane of the target 14 moves, φ(t) is a phase of radiation SE emitted by the laser 11 (the phase of radiation φ(t) is the stimuli phase) and λ(t) is a wavelength of the radiation SE emitted by the laser 11.

So even if Lopt(t) is constant, the wavelength λ(t) will still vary (e.g. due to the heating of the laser cavity which is e.g. a VCSEL cavity). According to the excess phase equation, the photodetector current IPD is generated as shown in FIG. 1C on the left top side. The two SMI periods are stretched out in time differently, as dλ/dt is not a flat curve: A higher dλ/dt causes a shorter SMI period; a lower dλ/dt causes a wider SMI period.

An effect of this is that a phase shift caused by membrane displacement will cause a smaller shift in time in SMI period T1 than it would in SMI period T2. Additionally, the time shift within each SMI period is not equal either, as the rate of change dλ/dt of lambda also varies within each SMI period. This will cause distortion that follows the curve of rate of change of lambda k. In short: When the phase (t) is shifted by displacement of the membrane, the phase shift is also dependent on the rate of change of lambda λ.

In FIG. 2G, the first period T1 is measured from a first peak or first maximum of the input signal SIN (e.g. which is the photodetector current IPD) to a second peak or second maximum of the input signal SIN. The second period T2 is measured from a second peak or second maximum of the input signal SIN to a third peak or third maximum of the input signal SIN.

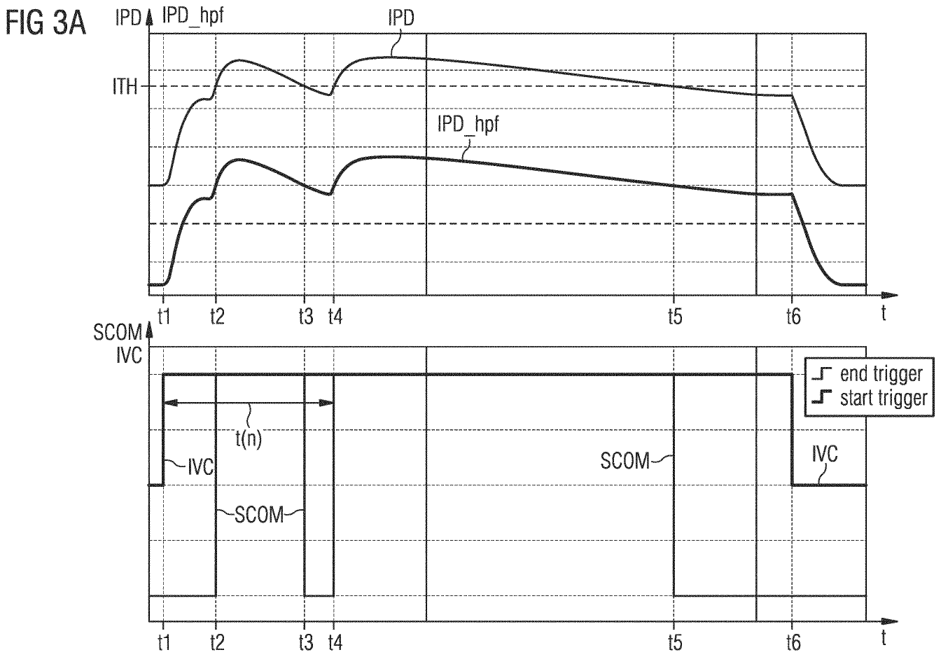

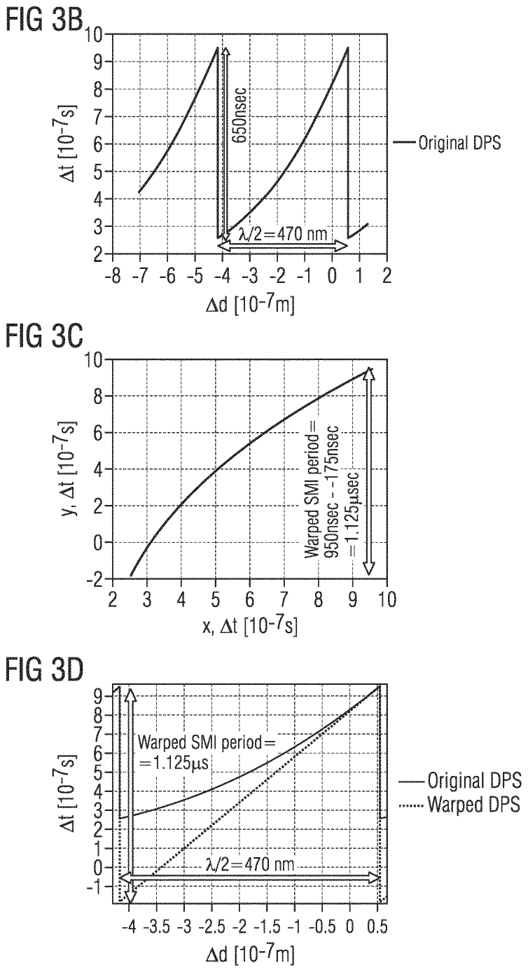

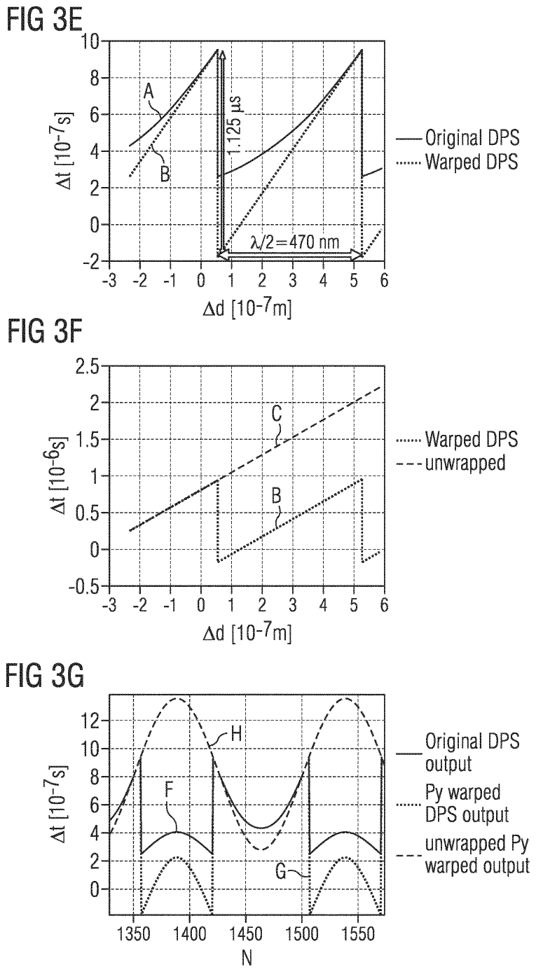

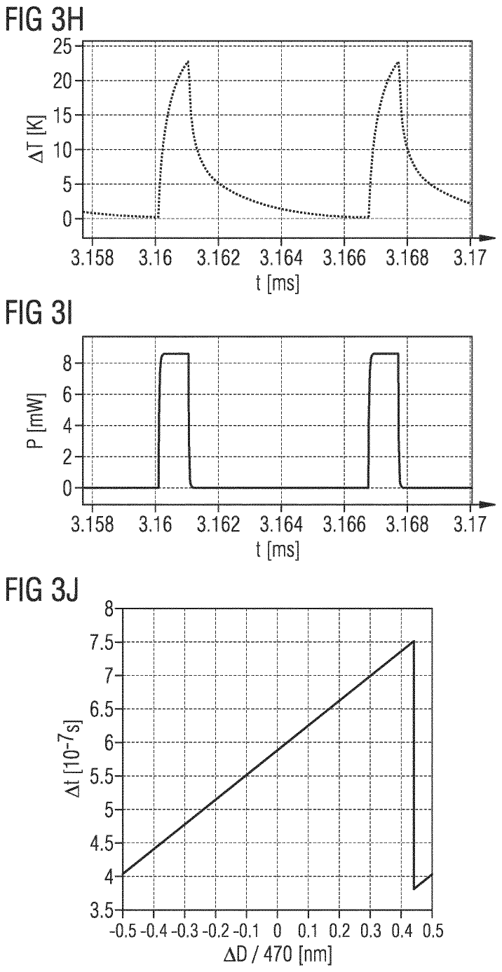

FIG. 3A shows an exemplary embodiment of signals of a distance measurement arrangement 40 with an optoelectronic device 10 which is a further development of the embodiments shown above. The photodetector current IPD, a modified value IPD_hpf, the comparator signal SCOM and the laser current IVC are shown as a function of the time t. The modified value IPD_hpf is the photodetector current IPD from which a mean value of the photodetector current IPD is subtracted. The modified value IPD_hpf is e.g. an example for a signal derived from the input signal SIN.

At a first point of time t1, a pulse of the laser current IVC starts. The pulse of the laser current IVC ends at a sixth point of time t6.

The photodetector current IPD rises above a threshold value ITH at a second point of time t2 which is after the first point of time t1. The photodetector current IPD falls below the threshold value ITH at a third point of time t3 which is after the second point of time t2.

The photodetector current IPD rises a second time above the threshold value ITH at a fourth point of time t4 which is after the third point of time t3. The photodetector current IPD falls below the threshold value ITH at a fifth point of time t5 which is after the fourth point of time t4. The sixth point of time t6 follows the fifth point of time t5.

For providing a signal to the input 26 of the TDC 25, the following durations can be used for example:
the duration of the first period of the input signal SIN (which is the photodetector current IPD or the laser voltage UVC or a signal derived from IPD or UVC): t3-t2
the duration of the second period of the input signal SIN: t5-t4
the duration between the two rising edges of the input signal SIN: t4-t2
the duration between the two falling edges of the input signal SIN: t5-t3
the duration between the start of the pulse of the laser current IVC and the start of the first period of the input signal SIN: t2-t1
the duration between the start of the pulse of the laser current IVC and the start of the second period of the input signal SIN: t4-t1
the duration between the start of the pulse of the laser current IVC and the end of the first period of the input signal SIN: t3-t1
the duration between the start of the pulse of the laser current IVC and the end of the second period of the input signal SIN: t5-t1

Alternatively, other signals or derived signals or durations can also be used. Also multiple times can be used, e.g., t3-t2 and t5-t4 or, alternatively, t2-t1 and t4-t1; so more periods are used for each VCSEL pulse.

As explained below, typically, the duration between the start of the pulse of the laser current IVC and the start of the second period of the input signal SIN (namely t4-t1) is used for time-to-digital conversion by the TDC 25.

The DPS read-out algorithm is performed as follows: The time from start pulse t1 to the last steep fringe edge t4 is measured by the optoelectronic device 10. This pulse length t4-t1 is the t(n) sample, shown in the bottom of FIG. 3A. When the membrane excursion gets larger and the steep fringe falls out of the pulse window, then the optoelectronic device 10 only measures the time to the second steep fringe. In this case, there is a jump to another fringe and the measured time needs to be unwrapped to handle the fringe jumping (membrane displacement Δd>/2). Only the comparator output at a positive edge is used. The comparator output at a negative edge is not used.

The DPS measures the time from start pulse to the last steep fringe edge, i.e. the last SMI period in the pulse. The comparator 22 with hysteresis triggers e.g. on zero crossing. The start trigger rising edge is the start of the pulse. The rising edge of the comparator signal SCOM indicates the current fringe position (in time). The output from DPS is the time from rising edge of the start trigger to the rising edge of the end trigger. In an example, there are three time measurements within a pulse.

In an alternative embodiment, the optoelectronic device 10 measures a duration, wherein the duration starts with the steep edge of the input signal SIN (e.g. the last steep edge of the input signal SIN) and ends with the falling edge of the control signal CNT to the driver 20 or the falling edge of the laser current ICV. Thus, the steep edge of the input signal SIN is used as the start pulse and the end pulse is the falling edge of the control signal CNT to the VCSEL driver 20 or of the laser current ICV.

FIG. 3B to 3D show exemplary embodiments of signals and characteristics of a distance measurement arrangement 40 with an optoelectronic device 10 which is a further development of the embodiments shown above. The optoelectronic device 10 performs a DPS input/output characteristic linearization using time warping. The input/output response is linearized by warping each original YT(n) to a new domain or sample called YW(n). This is possible, since the IO curve is monotone within a SMI period. The warping is then done by polynomial fitting of a function, e.g.:

$$YW ( n ) = f ( x ) = Warp ( x ) and x = Y T ( n ) ,$$

$$or$$

$$YW ( n ) = f ( Y T ( n )$$

to stretch the time samples YT(n). In an example:

$$YW ( n ) = f ( x ) = a + b x + c {x}^{2} + d {x}^{3} + e {x}^{4}$$

wherein x=YT(n) and a, b, c, d and e are coefficients (c is not equal zero; d is zero or non-zero; e is zero or non-zero).

The fitting of Warp(x) is based on the input/output response, abbreviated IO response, and the wanted output signal SOUT has a linear slope. The shape of the warping is determined by the heating response of the laser 11. A procedure to find IO response can be investigated e.g. by applying acoustical stimuli larger than λ/2. Alternative linearization method can also be used.

In FIG. 3B, the response to a linear sweep of the distance difference Δd is shown. A time difference Δt is plotted as a function of the distance difference Δd. The time difference Δt is the duration between the fourth point of time t4 and the first point of time t1 (other measures as mentioned above can also be used). YT(n) in the equation above is the time difference Δt in FIG. 3B. The difference Δt could, theoretically, be obtained by plotting each measured YT(n) versus the distance difference Δd, when Δd is increased in small steps for each sample. In an example, a value of a SMI period is: SMI period=900 ns−250 ns=650 ns

In FIG. 3C, the time warping y=Warp(x) is shown to obtain a linear IO response. y is plotted versus x. The arrow shows a warped SMI period=950 ns−175 ns=1.125 μs. In FIG. 3C, a plot of the corresponding warping function f(x)=warp(x) and x=YT(n) is elucidated, wherein x, Δt is shown on the x-axis. The f(x) function can be approximated by a polynomial or a piecewise polynomial or another function. This function is implemented in digital hardware/software in the second process 38 in FIGS. 1C and 1D. The approximated function can be called f_app(x). The warping function is configured to stretch out the original DPS samples YT(n) in order to have a linear relation between Δd and YW(n).

In FIG. 3D, the IO response for a whole SMI period is shown. The time difference Δt is plotted versus the distance difference Δd. The dependency is linear. In FIG. 3D, the warped output of the measured input YT(n) is shown: YW(n)=f app(YT(n)). For example: the laser current IVC=4 mA.

FIG. 3E to 3G show exemplary embodiments of signals and characteristics of a distance measurement arrangement 40 with an optoelectronic device 10 which is a further development of the embodiments shown above. An unwrapping is performed to handle membrane excursion >λ/2. The unwrapping algorithm calculates the differential:

$$diff ( n ) = y ( n ) - y ( n - 1 ) .$$

If abs(diff(n)) is larger than 0.5·SMI period, a fringe jump has occurred. The sign of diff(n) determines, if the SMI period should be subtracted or added to perform an unwrapping. The unwrapping scheme works under the condition that the heating is large enough to have at least one SMI period within the pulse duration (that is t6-t1) of the laser current IVC. In FIGS. 3E and 3F, the response to a linear sweep of the distance difference Δd is shown; the time difference Δt is shown as a function of the distance difference Δd.

In FIG. 3E, the original DPS response is marked with A, the warped DPS response is marked with B.

In FIG. 3F, the warped DPS response is marked with B and the unwrapped response is marked with C.

In FIG. 3G, the time difference Δt is shown as a function of a sample number N. The original DPS output is marked with F, the Py warped DPS output is marked with G, the unwrapped Py warped output is marked with H.

FIGS. 3H to 3J show exemplary embodiments of signals and characteristics of a distance measurement arrangement 40 with an optoelectronic device 10 which is a further development of the embodiments shown above.

In FIG. 3H, a simulated heat transfer function is shown; thus, a temperature change ΔT is elucidated as a function of the time t. In FIG. 3I, a power P provided to the laser 11 is shown as function of the time t. The power P is a heating power. The power P has approximately a rectangular pulse form. In FIG. 3J, a simulation of an input Δd and an output Δt is explained. The time difference Δt is shown as a function of the distance difference Δd divided by 470 nm. Δd/470 nm is equal to the number of SMI periods. The time t(n) increases linearly with the distance difference Δd (IVC=4 mA).

The invention is not limited to the description of the embodiments. Rather, the invention comprises each new feature as well as each combination of features, particularly each combination of features of the claims, even if the feature or the combination of features itself is not explicitly given in the claims or embodiments.

### REFERENCE NUMERALS

10 optoelectronic device
11 laser
12 integrated circuit
13 output
14 target
15 photodetector
20 driver
21 signal input
22 comparator
23 input
24 output
25 time-to-digital converter
26 input
27 output
28 subtracting/additive circuit
29 oscillator
30 signal evaluation circuit
31 input
32 output
33 further input
34 control circuit
35 time to voltage converter
36 voltage to digital converter
37-39 process
40 distance measurement arrangement
AUD audio signal
CNT control signal
d distance
IPD photodetector current
IVC laser current
ITH threshold value
SCOM comparator signal
SE electromagnetic radiation
SIN input signal
SOUT output signal
SR reflected radiation
t time
t1-t6 point of time
UVC laser voltage
YT duration signal
YU unwrapped signal
YW warped signal
Δd distance difference
Δt time difference
λ wavelength

1. An optoelectronic device, which is configured as a self-mixing interferometer and comprises:
a laser,
a driver with an output coupled to the laser,
a signal input,
a comparator with an input coupled to the signal input,
a time-to-digital converter with an input coupled to an output of the comparator, and
a signal evaluation circuit with an input coupled to an output of the time-to-digital converter and with an output, wherein the signal evaluation circuit is configured to provide an output signal at the output.

2. The optoelectronic device of claim 1,
wherein the laser is realized as vertical-cavity surface-emitting laser.

3. The optoelectronic device of claim 1,
wherein the comparator is implemented as a Schmitt trigger circuit or as an amplifier.

4. The optoelectronic device of claim 1,
wherein the driver is configured to provide a laser current to the laser such that the laser current has a pulse form and a pulse is periodically repeated.

5. The optoelectronic device of claim 4,
wherein the time-to-digital converter is configured to measure a duration between a first and a second edge and to generate a duration signal as a function of the duration between the first and the second edge.

6. The optoelectronic device of claim 5,
wherein an input signal is tapped at the signal input and a control signal is tapped at an input of the driver,
wherein the first edge is a rising edge of the laser current, an edge of the control signal, an edge of the input signal or an edge of a signal derived from the input signal, and
wherein the second edge is a further edge of the input signal or a further edge of the signal derived from the input signal.

7. The optoelectronic device of claim 5,
wherein an input signal is tapped at the signal input and a control signal is tapped at an input of the driver,
wherein the first edge is an edge of the input signal or an edge of a signal derived from the input signal, and
wherein the second edge is a falling edge of the laser current, an edge of the control signal, a further edge of the input signal or a further edge of the signal derived from the input signal.

8. The optoelectronic device of claim 1,
wherein the signal evaluation circuit is configured to linearize a duration signal provided by the time-to-digital converter.

9. The optoelectronic device of claim 8,
wherein the signal evaluation circuit is configured to linearize the duration signal by:
generating a warped signal by warping the duration signal, and
generating an unwrapped signal by unwrapping the warped signal.

10. The optoelectronic device of claim 9,
wherein generating a warped signal by warping the duration signal is performed by polynomial or piecewise polynomial evaluating the duration signal.

11. The optoelectronic device of claim 9,
wherein generating an unwrapped signal by unwrapping the warped signal is performed by using the equation
$$YU ( n ) = function\_unwrap ( Y W ( n ) , C , Y\_SMI \_PERIOD ) ,$$
wherein YU(n) is a nth value of the unwrapped signal, YW(n) is a nth value of the warped signal, C is an integer and Y_SMI_PERIOD is a constant.

12. The optoelectronic device of claim 9,
wherein the signal evaluation circuit is configured to generate the output signal by filtering and/or amplification the unwrapped signal.

13. The optoelectronic device of claim 1,
wherein the time-to-digital converter comprises
a time-to-voltage converter coupled to the input of the time-to-digital converter and
a voltage-to-digital converter coupled to an output of the time-to-voltage converter and to the output of the time-to-digital converter.

14. The optoelectronic device of claim 1,
wherein the time-to-digital converter comprises an oscillator.

15. The optoelectronic device of claim 1,
wherein the driver is configured to provide a laser current to the laser, and
wherein the signal input is coupled to the laser and is configured to receive a laser voltage tapped at the laser.

16. The optoelectronic device of claim 1,
wherein the optoelectronic device comprises a photodetector with an output coupled to the signal input.

17. A distance measurement arrangement, comprising
the optoelectronic device of claim 1, and
a target,
wherein the laser is configured to emit electromagnetic radiation,
wherein the target is configured to provide the electromagnetic radiation as reflected radiation to the optoelectronic device, and
wherein the optoelectronic device is configured to detect the reflected radiation.

18. (canceled)

19. The distance measurement arrangement of claim 17,
wherein the signal evaluation circuit is configured to generate the output signal such that the output signal of the optoelectronic device is an audio signal, and
wherein the target is a membrane of a microphone or a display.

20. A method for generating an output signal, comprising:
emitting electromagnetic radiation by a laser,
generating an input signal at a signal input,
generating a comparator signal by comparing the input signal or a signal derived from the input signal with a threshold value signal by a comparator,
generating a duration signal by a time-to-digital converter as a function of the comparator signal, and
providing an output signal by a signal evaluation circuit as a function of the duration signal.

21. An optoelectronic device, which is configured as a self-mixing interferometer and comprises:
a laser,
a driver with an output coupled to the laser,
a signal input,
a comparator with an input coupled to the signal input,
a time-to-digital converter with an input coupled to an output of the comparator, and
a signal evaluation circuit with an input coupled to an output of the time-to-digital converter and with an output, wherein the signal evaluation circuit is configured to provide an output signal at the output,
wherein the time-to-digital converter is configured to measure a duration between a first and a second edge and to generate a duration signal as a function of the duration between the first and the second edge, and
wherein an input signal is tapped at the signal input and a control signal is tapped at an input of the driver.
